(19) United States
(12) Patent Application Publication
(10) Pub. No.: US 2009/0280339 A1
(43) Pub. Date: Nov. 12, 2009

(54) POLYIMIDE FILM, POLYIMIDE METAL LAMINATE USING SAME, AND METHOD FOR MANUFACTURING SAME

(75) Inventors: Takeshi Tsuda, Chiba (JP); Eiji Ohtsubo, Chiba (JP); Masao Kawaguchi, Chiba (JP); Shuji Tahara, Chiba (JP); Kenji Iida, Chiba (JP)

Correspondence Address: BUCHANAN, INGERSOLL & ROONEY PC, POST OFFICE BOX 1404, ALEXANDRIA, VA, 22313-1404, US

(73) Assignee: Mitsui Chemicals ,Inc., Minato-ku ,Tokyo (JP)

(21) Appl. No.: 11/885,455

(22) PCT Filed: Apr. 5, 2006
(86) PCT No.: PCT/JP2006/307247

§ 371 Date: Aug. 31, 2007

(30) Foreign Application Priority Data
Apr. 8, 2005 (JP) 2005-112116

(51) Int. Cl. B32B 15/08; B32B 27/00; B32B 37/14

(52) U.S. Cl. 428/458; 156/314; 428/473.5

(57) ABSTRACT

Disclosed is a polyimide metal laminate having a metal layer with high adhesiveness. This polyimide metal laminate is suitable as a material for high-density circuit boards. Specifically disclosed is a polyimide film characterized by being surface-treated with an aqueous solution containing an alcohol amine and an alkali metal hydroxide. Also specifically disclosed is a polyimide metal laminate obtained by providing the surface of such a polyimide film with a thermoplastic polyimide and then forming a metal layer on the outer side of the thermoplastic polyimide layer. Further specifically disclosed is a method for manufacturing such a polyimide metal laminate.

### TECHNICAL FIELD

The present invention relates to a polyimide film and a polyimide metal laminate using such a polyimide film and a method for manufacturing such a polyimide metal laminate. More particularly, the invention relates to a polyimide film, a polyimide metal laminate excellent in adhesiveness to a metal layer and suitable as a material for high-density circuit boards, and a method for manufacturing such a polyimide metal laminate.

### BACKGROUND ART

A polyimide metal laminate has been mainly used as a material for circuit boards, and used as a base material for printed wiring boards, a base material for an integrated suspension, a base material for a wiring for IC packages, a flat heating unit, a base material for a wiring for LCDs and the like. In recent years, with miniaturization and high-density trend in electronic equipment, a polyimide metal laminate capable of realizing high-density mounting of parts and elements has been increasingly used. Furthermore, in order to achieve high-density circuits, miniaturization to make a line width 10 to 50 μm in circuit patterns has been attempted. For that reason, a polyimide metal laminate excellent in adhesiveness of a meal layer to a polyimide film has been in demand. For use in this material for circuit boards, a polyimide film and a metal foil (for example, a copper foil) have been usually bonded together with various adhesives and used. However, even though a polyimide film is bonded by using an adhesive, its adhesiveness to a copper foil is not sufficient in many cases due to its chemical structure and high chemical (solvent) resistance stability. So, under the current circumstances, a polyimide film is subjected to various surface treatments (for example, a coating treatment with a coupling agent, a sandblast treatment, a corona discharge treatment, a plasma treatment, an alkali treatment and the like), and then a metal foil is bonded thereto with an adhesive.

A polyimide film subjected to a surface treatment by a coating treatment with a coupling agent might possibly deteriorate electrical properties due to Si residue. Furthermore, a sandblast treatment has a problem in a washing step for removing an abrasive attached on the polyimide film. On the other hand, from the fact that the equipment for a corona discharge treatment and a plasma treatment is simple, the equipment can also be integrated into a film-forming device (inline type). Such treatments are favorable treatments by which a little improvement in adhesiveness is recognized. However, when a metal foil is bonded by using a polyimide based adhesive as an adhesive to a polyimide film subjected to a corona discharge treatment or a plasma treatment, improvement in adhesiveness is never recognized and there has been a problem in a treatment as a practical matter.

Furthermore, it has also been known a technique capable of improving adhesiveness to a metal layer by subjecting a surface of a polyimide film to an alkali treatment (refer to Patent Document 1 and the like). However, in Patent Document 1, there has only been described that adhesiveness has been improved just by treating a polyimide film simply with an alkali solution, but there has not been described any review on the composition of the alkali solution, and adhesiveness has been lowered in some cases.

Furthermore, since the wetting property on a surface of a polyimide film is not generally high, defects in the shape of a dent called crater, eye hole or dimple might be generated in some cases when a polyimide based adhesive is applied on the surface of the polyimide film, as reviewed by the present inventors. Such a defect portion in the shape of a dent becomes a void when a metal foil is laminated. There have been a problem such as broken wiring, peeling or the like caused by an etching solution which was infiltrated into such a void portion when fine wiring of high-density circuits is formed.

On the other hand, it has been reported that the adhesive strength of a polyimide resin to a metal film formed on a surface of a polyimide resin is increased when an ultraviolet ray is radiated on a surface of the polyimide resin which is roughened by wet etching. The examples of the wet etching include treating with an etching solution containing an oxyalkylamine and an alkali metal compound as main components, and then treating with an oxidant (refer to Patent Document 2).

Patent Document 1: Japanese Patent Application Laid-open No. 2004-533723

Patent Document 2: Japanese Patent Laid-open No. 11-293009

### DISCLOSURE OF THE INVENTION

### Problems to be Solved by the Invention

An object of the present invention is to provide a polyimide film excellent in the wetting property and having high adhesiveness with a metal foil to be bonded by using a polyimide adhesive, and a polyimide metal laminate which is manufactured by using such a polyimide film.

### Means for Solving the Problem

In order to solve the above problems, the present inventors have conducted an extensive study and as a result, have found that the above problems can be solved by subjecting a polyimide film comprising a non-thermoplastic polyimide layer of a polyimide metal laminate having a non-thermoplastic polyimide layer, a thermoplastic polyimide layer and a metal layer laminated thereto in order to a surface treatment with an aqueous solution containing an alcohol amine and an alkali metal hydroxide. Thus, the present invention has been completed.

Namely, the present invention relates to the following:

[1] a polyimide film subjected to a surface treatment with an aqueous solution containing an alcohol amine and an alkali metal hydroxide;

[2] the polyimide film according to [1], wherein a weight content of the alcohol amine (A weight %) is not less than 5 weight % and not more than 75 weight %, the weight content of the alkali metal hydroxide (B weight %) is not less than 10 weight % and not more than 45 weight %, and the weight content of water (C weight %) is not less than 9 weight % and not more than 80 weight % in said aqueous solution;

[3] the polyimide film according to [1] or [2], wherein the alcohol amine is one or more kinds selected from the group consisting of ethanol amine, propanol amine, butanol amine, diethanol amine and dipropanol amine, and the alkali metal hydroxide is one or more kinds selected from the group consisting of potassium hydroxide and sodium hydroxide;

[4] the polyimide film according to any one of [1] to [3], wherein the polyimide film contains a condensation polymer of a raw material composition containing an acid dianhydride component including at least one of a pyromellitic acid dianhydride and a biphenyl tetracarboxylic acid dianhydride, and a diamine component including at least one of phenylene diamine and diaminodiphenyl ether;

[5] a polyimide metal laminate having the polyimide film according to any one of [1] to [4], a thermoplastic polyimide layer comprising a resin composition containing a thermoplastic polyimide placed on at least one surface of said polyimide film, and a metal layer placed on the outer side of said thermoplastic polyimide layer; and

[6] a method for manufacturing a polyimide metal laminate comprising steps of: subjecting at least one surface of a polyimide film to a surface treatment with an aqueous solution containing an alcohol amine and an alkali metal hydroxide, forming a thermoplastic polyimide layer by coating the surface subjected to the surface treatment of the polyimide film with a resin composition containing a thermoplastic polyimide or a thermoplastic polyimide precursor and drying, and forming a metal layer by heat-pressing a metal foil on the thermoplastic polyimide layer.

### EFFECT OF THE INVENTION

According to the present invention, it is possible to obtain a polyimide film excellent in the wetting property and having high adhesiveness with a metal foil to be bonded by using a polyimide adhesive, and it is possible to provide a polyimide metal laminate suitable for a material for high-density circuit boards by using such a polyimide film.

### BEST MODE FOR CARRYING OUT THE INVENTION

A polyimide film, a polyimide metal laminate and a method for manufacturing such a polyimide metal laminate of the present invention are described in detail below.

1. Polyimide Film of Present Invention

The polyimide film of the present invention is a film obtained through treating a surface of the polyimide film with an aqueous solution containing an alcohol amine and an alkali metal hydroxide.

The material of the polyimide film of the present invention is not particularly limited, but it is preferably a film comprising a resin composition containing a non-thermoplastic polyimide. The non-thermoplastic polyimide is a condensation polymer of a raw material composition containing an acid dianhydride component and a diamine component. It is preferable that the raw material composition of the non-thermoplastic polyimide contained in the polyimide film includes a pyromellitic acid dianhydride and/or a biphenyl tetracarboxylic acid dianhydride as an acid dianhydride component, and a phenylene diamine and/or a diaminodiphenyl ether as a diamine component. The polyimide film containing the non-thermoplastic polyimide that is a condensation polymer of the raw material composition exhibits a particularly remarkable effect in the present invention. Incidentally, the raw material composition of the non-thermoplastic polyimide constituting the polyimide film of the present invention is not limited to the aforementioned compounds, and there is no problem even if it further contains a diamine and an acid dianhydride known in the art as long as the effect of the present invention is not damaged.

Furthermore, a thermoplastic polyimide resin and the like may be further blended into the resin composition constituting the polyimide film.

In the present invention, as the surface-treated polyimide film, commercially available polyimide films can also be used. For example, preferably used are UPILEX S (product name, registered trademark) manufactured by UBE Industries, Ltd., APICAL NPI and APICAL AH (product names, registered trademarks) manufactured by Kaneka Corporation, KaptonV and KaptonEN (product names, registered trademarks) manufactured by Du Pont-Toray Co., Ltd. and the like.

The thickness of the polyimide film of the present invention is not particularly limited, and it can be selected depending on the purpose. The thickness of the polyimide film of the present invention is preferably in the range of 5 to 250 μm, more preferably from 5 to 50 μm, and further preferably from 5 to 25 μm.

As described above, the polyimide film of the present invention is characterized in that its surface is treated with an aqueous solution containing an alcohol amine and an alkali metal hydroxide. The surface of the film to be treated may be one surface or both surfaces of the film.

An aqueous solution used for a surface treatment of a polyimide film is not particularly limited as long as an aqueous solution contains an alcohol amine and an alkali metal hydroxide. As a preferable composition, the weight content of the alcohol amine (A weight %) contained in the aqueous solution is not less than 5 weight % and not more than 75 weight %, the weight content of the alkali metal hydroxide (B weight %) is not less than 10 weight % and not more than 45 weight %, and the weight content of water (C weight %) is not less than 9 weight % and not more than 80 weight %. As a more preferable composition, the weight content of the alcohol amine (A weight %) contained in the aqueous solution is not less than 5 weight % and not more than 25 weight %, the weight content of the alkali metal hydroxide (B weight %) is not less than 10 weight % and not more than 30 weight %, and the weight content of water (C weight %) is not less than 40 weight % and not more than 80 weight %. As a further preferable composition, the weight content of the alcohol amine (A weight %) contained in the aqueous solution is not less than 5 weight % and not more than 10 weight %, the weight content of the alkali metal hydroxide (B weight %) is not less than 10 weight % and not more than 20 weight %, and the weight content of water (C weight %) is not less than 70 weight % and not more than 80 weight %. However, A+B+C does not exceed 100.

Examples of the alcohol amine contained in the aqueous solution which can be used for the above surface treatment include ethanol amine, propanol amine, butanol amine, diethanol amine, dipropanol amine and the like, and one or more kinds are selected therefrom.

Examples of the alkali metal hydroxide include potassium hydroxide, sodium hydroxide, lithium hydroxide and the like. Preferably, one or more kinds are selected from potassium hydroxide and sodium hydroxide.

In the present invention, a means for treating the surface of the polyimide film with an aqueous solution containing an alcohol amine and an alkali metal hydroxide is not particularly limited. The surface treatment can be conducted by immersing the polyimide film into an aqueous solution put in a batch type bath; spraying the aqueous solution on the polyimide film by using a spray, a shower or the like. Furthermore, the surface treatment may be continuously carried out according to a roll-to-roll method capable of conveying.

The treatment conditions are not particularly limited. When the treatment is conducted at an excessively high temperature for a long time, the thickness of the polyimide film becomes thin in some cases; therefore it is not preferable. So, the liquid temperature of the aqueous solution is preferably from 10 to 90° C. and more preferably from 15 to 85° C. The time required for the treatment is preferably from about 0.03 to 10 minutes and more preferably from about 0.08 to 5 minutes. Furthermore, when the temperature of the aqueous solution is low, it takes time for the reaction in some cases. And when the polyimide film surface is treated with an aqueous solution at a very high temperature, it is difficult to have a smooth surface in some cases.

Before the surface of the polyimide film is treated with an aqueous solution containing an alcohol amine and an alkali metal hydroxide, it can be subjected to a swelling treatment with an alkaline solution.

In the present invention, the surface treatment of the polyimide film is considered to generate an amide group by hydrolyzing at least a part of an imide group present in the surface of the polyimide film. The generated amide group is considered to have an anchor effect between the thermoplastic polyimide or the thermoplastic polyimide precursor (described later) and the polyimide film surface, and to enhance adhesiveness to the laminated metal layer. However, the mechanism of this is not limited.

It is preferable that the surface of the polyimide film of the present invention has higher wetting property than a surface of a film before subjected to a surface treatment. “High wetting property” includes a case where the contact angle of a drop of water on a surface is small. For example, due to the improvement of the wetting property varnish (described later) can be properly applied.

It is preferable that the polyimide film of the present invention is not subjected to roughness treatment after subjected to a surface treatment with an aqueous solution. Herein, “roughness treatment” includes a case where a treatment with an oxidant (permanganate, chromic acid or the like) is conducted in order to roughen the surface after a surface treatment with an aqueous solution.

Furthermore, it is preferable that the surface of the polyimide film of the present invention is practically smooth. “Practically smooth” includes for example a case where a relief structure is not practically detectable in observation with SEM.

In the present invention, it is preferable that the surface treatment of the polyimide film does not cause a change in the thickness of the polyimide film. “Do not cause a change in the thickness” means that a change of 1 μm and more is not caused.

The polyimide film of the present invention can be used for arbitrary purposes. It is preferable that since the surface-treated side of the film has a property of high adhesiveness to a thermoplastic polyimide applied thereon, a thermoplastic polyimide layer containing a thermoplastic polyimide is formed on at least one surface of the polyimide film and a metal layer is further formed on the outer side of the thermoplastic polyimide layer, whereby a polyimide metal laminate is provided.

2. Polyimide Metal Laminate of Present Invention

The polyimide metal laminate of the present invention includes the polyimide film as described above, the thermoplastic polyimide layer containing a thermoplastic polyimide placed on at least one surface of the polyimide film, and the metal layer placed on the outer side of the thermoplastic polyimide layer. In the polyimide metal laminate of the present invention, the thermoplastic polyimide layer and the metal layer may be laminated on the surface-treated side of the above polyimide film. The thermoplastic polyimide layer and the metal layer may be laminated only on one side thereof, or laminated on both sides.

The thermoplastic polyimide layer included in the polyimide metal laminate of the present invention can be an adhesive layer for enhancing adhesiveness between the metal layer and the film. The thickness of the thermoplastic polyimide layer is selected depending on the purpose of use of the polyimide metal laminate to be manufactured and is not limited, but it is preferably in the range of 0.5 to 10 μm.

The thermoplastic polyimide layer included in the polyimide metal laminate of the present invention is a layer comprising a resin composition containing a thermoplastic polyimide. Bismaleimide may also be contained in the resin composition constituting the thermoplastic polyimide layer, in addition to the thermoplastic polyimide (bismaleimide to be described later).

As the thermoplastic polyimide contained in the thermoplastic polyimide layer, a known thermoplastic polyimide obtained through leading a raw material composition containing a diamine component and a tetracarboxylic acid dianhydride component to a polycondensation reaction can be used. A glass transition temperature Tg of the thermoplastic polyimide contained in the thermoplastic polyimide layer is preferably from 100 to 300° C.

Concrete examples of the diamine contained in the raw material composition of the thermoplastic polyimide include 1,3-bis(3-aminophenoxy)benzene, 4,4′-bis(3-aminophenoxy)biphenyl, 1,3-bis(3-(3-aminophenoxy)phenoxy)benzene, bis(3-(3-aminophenoxy)phenyl)ether, bis(3-(3-(3-aminophenoxy)phenoxy)phenyl)ether, o-phenylene diamine, p-phenylene diamine, m-phenylene diamine, 4,4′-diaminodiphenylmethane, 3,4′-diaminodiphenylmethane, 3,3′-diaminodiphenylmethane, 4,4′-diaminodiphenyl ether, 3,3′-diaminodiphenyl ether, 3,4′-diaminodiphenyl ether, 4,4′-diaminobenzophenone, 3,4′-diaminobenzophenone, bis(4-aminophenyl)sulfone, bis(4-(3-aminophenoxy)phenyl)sulfone, bis(3-aminophenyl)sulfide, bis(4-aminophenyl)sulfide, 1,3-bis(4-(4-aminophenoxy)-α,α-dimethylbenzyl)benzene, 2,2-bis(4-aminophenoxyphenyl)propane, 1,3-bis(1-(4-(4-aminophenoxy)phenyl)-1-methylethyl)benzene, 1,4-bis(1-(4-(4-aminophenoxy)phenyl)-1-methylethyl)benzene, 1,4-bis(1-(4-(3-aminophenoxy)phenyl)-1-methylethyl)benzene, 2,2-bis(3-(3-aminophenoxy)phenyl)-1,1,1,3,3,3-hexafluoropropane and 2,2-bis(3-(4-aminophenoxy)phenyl)-1,1,1,3,3,3-hexafluoropropane and the like. At least one diamine selected from 1,3-bis(3-aminophenoxy)benzene, 4,4′-bis(3-aminophenoxy)biphenyl and 1,3-bis(3-(3-aminophenoxy)phenoxy)benzene is preferably used. Further preferably used is a diamine selected from 1,3-bis(3-aminophenoxy)benzene and 1,3-bis(3-(3-aminophenoxy)phenoxy)benzene.

The tetracarboxylic acid dianhydride contained in the raw material composition for the thermoplastic polyimide is not particularly limited and known compounds can be used. Concrete examples thereof include 3,3′,4,4′-benzophenone tetracarboxylic acid dianhydride, pyromellitic acid dianhydride, 3,3′,4,4′-biphenyl tetracarboxylic acid dianhydride, oxy-4,4′-diphthalic acid dianhydride, 2,2-bis[4-(3,4-dicarboxyphenoxy)phenyl]propane dianhydride, ethylene glycol bistrimellitic acid dianhydride, 2,2-bis(3,4-dicarboxyphenyl)-1,1,1,3,3,3-hexafluoropropane dianhydride, 2,2′,3,3′-benzophenone tetracarboxylic acid dianhydride, 1,2-bis(3,4-dicarboxybenzoyl)benzene dianhydride, 1,3-bis(3,4-dicarboxybenzoyl)benzene dianhydride, 1,4-bis(3,4-dicarboxybenzoyl)benzene dianhydride, 2,2′-bis((3,4-dicarboxy)phenoxy)benzophenone dianhydride, 2,3′-bis((3,4-dicarboxy)phenoxy)benzophenone dianhydride, 2,4′-bis((3,4-dicarboxy)phenoxy)benzophenone dianhydride, 3,3′-bis((3,4-dicarboxy)phenoxy)benzophenone dianhydride, 3,4′-bis((3,4-dicarboxy)phenoxy)benzophenone dianhydride, 4,4′-bis((3,4-dicarboxy)phenoxy)benzophenone dianhydride and the like.

The aforementioned thermoplastic polyimide can be manufactured by known methods. For example, a raw material composition is obtained through mixing the aforementioned tetracarboxylic acid dianhydride component and the aforementioned diamine component in a predetermined ratio in a solvent such as N-methylpyrrolidone (NMP), dimethylformamide (DMF), dimethylacetamide (DMAc) dimethyl sulfoxide (DMSO), dimethyl sulfate, sulfolane, butyrolactone, cresol, phenol, halogenated phenol, cyclohexane, dioxane, tetrahydrofuran, diglyme, triglyme and the like. The obtained raw material composition is reacted at a reaction temperature in the range of 0 to 100° C. to obtain a thermoplastic polyimide precursor solution. The polyimide precursor is, for example, a polyamic acid. There is a method subjecting this solution to a heat treatment at a high temperature atmosphere of from 200 to 500° C. to cause imidization to give a thermoplastic polyimide solution.

The aforementioned thermoplastic polyimide precursor solution or the thermoplastic polyimide solution can be called “a varnish”.

The molar ratio of the diamine component and the tetracarboxylic acid dianhydride component contained in the raw material composition for the thermoplastic polyimide (a tetracarboxylic acid dianhydride component/a diamine component) is preferably in the range of 0.75 to 1.25, further preferably in the range of 0.90 to 1.10, and particularly preferably in the range of 1.00 to 0.97 because it is easy to control the reaction and the heat fluidity of the thermoplastic polyimide to be synthesized is suitable. Furthermore, in the raw material composition of the precursor solution (or varnish) of the thermoplastic polyimide, the total content of the diamine component and the tetracarboxylic acid dianhydride component is preferably from about 5 to 20 weight %.

To the resin composition constituting the thermoplastic polyimide layer, bismaleimide may be further combined in addition to the thermoplastic polyimide. Such an embodiment is preferable. Bismaleimide can be combined with the aforementioned varnish, and its combination amount may be determined depending on the concentration of the solid content (possibly a polyimide, a polyamic acid or a mixture thereof) contained in the varnish. The content of bismaleimide in the above resin composition is preferably from about to 20 weight % in the solid component contained in the varnish.

Concrete examples of the bismaleimide compound include 1,3-bis(3-maleimidephenoxy)benzene, bis(3-(3-maleimidephenoxy)phenyl)ether, 1,3-bis(3-(3-maleimidephenoxy)phenoxy)benzene, bis(3-(3-(3-maleimidephenoxy)phenoxy)phenyl)ether, 1,3-bis(3-(3-(3-maleimidephenoxy)phenoxy)phenoxy)benzene, N,N′-p-phenylenebismaleimide, N,N′-m-phenylenebismaleimide, bis(4-maleimidephenyl)methane, N,N′-4,4′-diphenyl ether bismaleimide, N,N′-3,4′-diphenyl ether bismaleimide, N,N′-3,3′-diphenyl ketone bismaleimide, 2,2-bis(4-(4-maleimidephenoxy)phenyl)propane, 2,2-bis(4-(3-maleimidephenoxy)phenyl)propane, 4,4′-bis(3-maleimidephenoxy)biphenyl, 2,2-bis(4-(3-maleimidephenoxy)phenyl)-1,1,1,3,3,3-hexafluoropropane, bis(4-(3-maleimidephenoxy)phenyl)ketone, bis(4-(3-maleimidephenoxy)phenyl)sulfide, bis(4-(3-maleimidephenoxy)phenyl)sulfone and the like. However, the bismaleimide compound is not limited to these examples. More preferably used is 1,3-bis(3-maleimidephenoxy)benzene.

The metal layer included in the polyimide metal laminate of the present invention is placed on the outer side of the thermoplastic polyimide layer. “placed on the outer side of the thermoplastic polyimide layer” includes a metal layer placed on a thermoplastic polyimide layer where a metal layer is directly in contact with a thermoplastic polyimide layer, and a metal layer placed on a thermoplastic polyimide layer via an intermediate layer. An intermediate layer is, for example, a resin layer, and can be an adhesive layer or a non-adhesive layer. It is preferable that the aforementioned metal layer may be directly in contact with the thermoplastic polyimide layer and placed thereon.

The kinds of the metal constituting the metal layer is not particularly limited, but examples of the metal include copper, a copper alloy, aluminum, nickel, stainless, titanium, iron and the like. Since the metal layer is subjected to an etching process and processed into an electronic circuit, the metal constituting the metal layer is preferably a metal having high electrical conductivity. From such a viewpoint, a metal layer is preferably composed of copper.

The thickness of the aforementioned metal layer is not particularly limited as long as the metal layer can be used in the shape of tape. And it is preferably from 2 to 150 μm and more preferably from 2 to 105 μm.

3. Method for Manufacturing Polyimide Metal Laminate of Present Invention

The metal laminate of the present invention can be manufactured by an arbitrary method. It can be preferably manufactured by preparing the aforementioned surface-treated polyimide film; coating the surface subjected to a surface treatment of the aforementioned polyimide film with a resin composition containing a thermoplastic polyimide or a thermoplastic polyimide precursor and drying to form a thermoplastic polyimide layer; heat-pressing a metal foil on the aforementioned thermoplastic polyimide layer to form a metal layer.

Furthermore, the metal laminate of the present invention may be manufactured by forming one or a plurality of intermediate layers on the above thermoplastic polyimide layer and heat-pressing a metal foil on the intermediate layer to form a metal layer.

The thermoplastic polyimide or the thermoplastic polyimide precursor (for example, a polyamic acid) is preferably dissolved in a solvent and applied on the surface of the polyimide film subjected to a surface treatment. A solution of a thermoplastic polyimide or a thermoplastic polyimide precursor dissolved in a solvent can be called “a varnish.” A precursor solution obtained by leading a raw material composition of a thermoplastic polyimide containing a tetracarboxylic acid dianhydride component, a diamine component and a solvent to a polycondensation reaction, or a polyimide solution obtained by leading the precursor solution to an imidization reaction may also be used as a varnish.

The concentration of the thermoplastic polyimide or the thermoplastic polyimide precursor contained in the varnish is preferably from 3 to 50 weight % and more preferably from 10 to 30 weight % based on the total weight of the varnish. Furthermore, bismaleimide may also be contained in the varnish.

As a means for coating the surface of the polyimide film with a varnish, known means such as a die coater, a comma coater, a roll coater, a gravure coater, a curtain coater, a spray coater and the like can be adopted. The coating means can be properly selected depending on the thickness of the thermoplastic polyimide layer to be formed, the viscosity of a varnish and the like.

The varnish applied on the polyimide film is dried and cured as needed. The term “Drying” includes an action of eliminating the solvent contained in the varnish, and the term “curing” includes an imidization of the polyimide precursor (for example, a polyamic acid). Drying and curing of the applied varnish can be conducted by using a usual heating and drying oven. The atmosphere in the drying oven is preferably filled with air, inert gas (nitrogen and argon) and the like. A temperature for drying and curing is properly selected according to the boiling point of a solvent and the like. It is preferably in the temperature range of 60 to 600° C. The time required for drying and curing is properly selected depending on the thickness of the thermoplastic polyimide layer to be formed, the concentration of a varnish, and the type of a solvent. It is preferably from about 0.05 to 500 minutes.

The polyimide metal laminate of the present invention is preferably manufactured by heat-pressing a metal foil on the thermoplastic polyimide layer placed on the surface subjected to a surface treatment of the aforementioned polyimide film. As the metal foil, known metal foils can be used. Examples of the known metal foil include a rolled annealed copper foil, an electrolytic copper foil, a copper alloy foil, an Al foil, a Ni foil, a stainless foil, a titanium foil, an iron foil and the like. Preferably used are a rolled copper foil and an electrolytic copper foil.

A method for heat-pressing a metal foil on a thermoplastic polyimide layer is not particularly limited, but representative examples include a heat-pressing method and/or a thermo-laminating method.

The heat-pressing method can comprise steps of cutting a polyimide film placed on a thermoplastic polyimide layer and a metal foil to correspond to a size of a pressing part of a pressing machine, superposing with each other, and heat-pressing by a heat press. The heating temperature is preferably in the temperature range of 150 to 600° C. The effective pressure is not limited, but is preferably from 0.1 to 500 kg/cm². The time required for pressurizing is not particularly restricted.

The thermo-laminating method is not particularly restricted, but refers to a method for carrying out lamination by putting a polyimide film including a thermoplastic polyimide layer and a metal foil between rolls. As the roll, a metal roll, a rubber roll and the like can be used. The material of the roll is not restricted, but as the metal roll, a steel material, a stainless material or the like is used. A roll which is chrome-plated on its surface is preferably used. As the rubber roll, the metal roll coated with heat resistant silicon rubber or fluorine type rubber is preferably. The laminating temperature is preferably in the range of 100 to 300° C. As a heating method, a radiation heating method such as far infrared or the like, an induction heating method and the like can also be used, in addition to a conduction heating method.

After the thermal lamination, it is also preferably to carry out a heat annealing. As the heating apparatus, a usual heating furnace, autoclave and the like can be used. The heat annealing can be conducted in an atmosphere such as air, inert gas (nitrogen and argon) or the like. As the heating method, any of a method for continuously heating a film or a method for leaving to stand at a heating furnace in a state that a film is wound on a core is preferable. As the heating method, a conduction heating method, a radiation heating method, a method of using the above methods together and the like are preferable. The annealing temperature is preferably in the temperature range of 200 to 600° C. The annealing time is preferably in the time range of 0.05 to 5,000 minutes.

The polyimide metal laminate of the present invention is excellent in adhesiveness of a metal layer to a polyimide layer. “Excellent in adhesiveness” means, for example, that a peel strength of a metal layer is high. This is illustrated in Examples to be described later. For that reason, the polyimide metal laminate of the present invention is suitably used as a material for circuit boards.

### EXAMPLES

The present invention is now described in detail below with reference to Examples and Comparative Examples. Incidentally, in Examples and Comparative Examples, characteristics of a polyimide film (wetting property of a surface and thickness), and adhesiveness (peel strength) between a metal layer and a polyimide layer in a polyimide metal laminate are evaluated as the following manner.

[Evaluation of Wetting Property]

The contact angle of water on the polyimide film surface was measured in the following procedure to give an index of the wetting property. Incidentally, the smaller contact angle indicates the better wetting property. A drop of water (a product of Wako Pure Chemical Industries, Ltd., pure water for high performance liquid chromatography) was added dropwise to the polyimide film surface from a micro syringe of a contact angle meter (a product of Kyowa Interface Science Co., Ltd., CA-S CYCLO) to measure the contact angle.

[Measurement of Thickness of Film]

The thickness of the polyimide film after subjected to an alkali treatment (surface treatment) was measured with a thickness gauge (a product of Mitutoyo Corporation, a digimatic indicator).

[Evaluation of Peel Strength]

In accordance with the method specified in JIS C-6471, a metal foil and a thermoplastic polyimide layer were peeled off from the short edge of a sample polyimide metal laminate (length: 100 mm, width: 3.2 mm) and the stress was measured. The measured value was taken as an index of the peel strength. The peel angle was 90° and the peel rate was 50 mm/min.

Synthesis Example of Thermoplastic Polyimide Precursor

69.16 g of 1,3-bis(3-aminophenoxy)benzene and 75.85 g of 3,3′,4,4′-benzophenone tetracarboxylic acid dianhydride were weighed, and dissolved in 822 g of N,N′-dimethylacetamide in a 1000-ml separable flask under a nitrogen flow. After dissolving, the resulting solution was continuously stirred at 60° C. for 6 hours and the polymerization reaction was carried out to obtain a polyamic acid solution. The content of a polyamic acid in the polyamic acid solution was 15 weight %. To 500 g of a part of the obtained varnish was added 13.24 g of 1,3-bis(3-maleimidephenoxy)benzene. The resulting mixture was stirred and dissolved at room temperature to give a polyamic acid varnish containing a bismaleimide compound. This varnish was taken as a thermoplastic polyimide precursor varnish.

### Example 1

### Manufacture of Polyimide Film

A commercially available non-thermoplastic polyimide film (a product of Du Pont-Toray Co., Ltd., product name: Kapton (registered trademark) 80EN, thickness: 20 μm) was immersed into an aqueous solution comprising 65 weight % of ethanol amine, 16 weight % of potassium hydroxide and 19 weight % of water at a temperature of 22° C. for 20 seconds, as shown in Table 1, and then washed with water and dried (this treatment is called “an alkali treatment”).

<Formation of Thermoplastic Polyimide Layer>

The thermoplastic polyimide precursor varnish synthesized in the above Synthesis Example was applied on both surfaces of the polyimide film obtained by an alkali treatment by using a reverse roll coater and dried to form a thermoplastic polyimide layer. The thickness of the thermoplastic polyimide layer after dried was 2.5 μm. Incidentally, drying was conducted step by step at 100, 150, 200 and 250° C. for 5 minutes of each by means of a thermal treatment.

### <Formation of Metal Layer>

As a metal foil to be bonded to a thermoplastic polyimide layer, a rolled annealed copper foil (a product of Nikko Materials Co., Ltd., product name: BHY-22B-T, thickness: 18 μm) was used. The obtained bondply both surfaces of which were respectively superposed with the rolled annealed copper foils was sandwiched between cushion materials (a product of Kinyosha Co., Ltd., product name: Kinyo Board F200), and the resulting material was heat-pressed under conditions of 300° C. and 25 kg/cm² for 4 hours by a heat pressing machine.

Accordingly, a polyimide metal laminate comprising [a rolled annealed copper foil/a thermoplastic polyimide layer/Kapton (registered trademark) 80EN/a thermoplastic polyimide layer/a rolled annealed copper foil] was prepared.

### Examples 2 to 5

### Manufacture of Polyimide Metal Laminate

A polyimide film and a polyimide metal laminate were manufactured in the same manner as in Example 1, except that the composition and treatment conditions of an aqueous solution for an alkali treatment were changed as shown in Table 1.

### Comparative Example 1

### Formation of Thermoplastic Polyimide Layer

As shown in Table 1, a commercially available non-thermoplastic polyimide film (a product of Du Pont-Toray Co., Ltd., product name: Kapton80EN, thickness: 20 μm) was not subjected to an alkali treatment and the polyamic acid varnish synthesized in the above Synthesis Example was applied on both surfaces of the polyimide film by using a reverse roll coater and dried to form a thermoplastic polyimide layer. The thickness of the thermoplastic polyimide layer after dried was 2.5 μm. Incidentally, drying was conducted step by step at 100, 150, 200 and 250° C. for 5 minutes of each by means of a thermal treatment.

<Formation of Metal Layer>

As a metal foil bonded to a thermoplastic polyimide layer, a rolled annealed copper foil (a product of Nikko Materials Co., Ltd., product name: BHY-22B-T, thickness: 18 μm) was used. The obtained bondply both surfaces of which were respectively superposed with the rolled annealed copper foils was sandwiched between cushion materials (a product of Kinyosha Co., Ltd., product name: Kinyo Board F200), and the resulting material was heat-pressed under conditions of 300° C. and 25 kg/cm² for 4 hours by a heat pressing machine. Accordingly, a polyimide metal laminate comprising [a rolled copper foil/a thermoplastic polyimide layer/Kapton (registered trademark) 80EN/a thermoplastic polyimide layer/a rolled annealed copper foil] was prepared.

### Comparative Examples 2 to 4

### Manufacture of Polyimide Metal Laminate

A polyimide metal laminate was manufactured in the same manner as in Example 1, except that the composition and treatment conditions of a treating solution were changed as shown in Table 1.

<Evaluation of Polyimide Film>

Polyimide films subjected to an alkali treatment and polyimide films which were not subjected to an alkali treatment respectively obtained from Examples 1 to 5 and Comparative Examples 2 to 4 were used to measure the contact angle of water as an index of the wetting property as described above. The results are shown in Table 1. Furthermore, the thickness of the polyimide film after subjected to an alkali treatment was measured as described above. The results are shown in Table 1.

<Evaluation of Polyimide Metal Laminate>

Polyimide metal laminates respectively obtained from Examples 1 to 5 and Comparative Examples 1 to 4 were used to measure the peel strength described above. The results are shown in Table 1.

TABLE 1

| | | Alkali treatment conditions | | | | | | | | |
|---|---|---|---|---|---|---|---|---|---|---|
| | | | | | | Treatment | | Evaluation of film | | Evaluation of |
| | | Composition of alkali solution | | | | conditions | | Contact | | metal laminate |
| | Polyimide | (weight %) | | | | Temperature | Time | angle | Thickness | Peel strength |
| | Film | Ethanolamine | KOH | NaOH | Water | (° C.) | (second) | (°) | (μm) | (KN/m) |
| Example 1 | Kapton80EN | 65 | 16 | 0 | 19 | 22 | 20 | 35 | 20 | 1.70 |
| Example 2 | Kapton80EN | 10 | 40 | 0 | 50 | 50 | 10 | 30 | 20 | 1.65 |
| Example 3 | Kapton80EN | 5 | 15 | 0 | 80 | 30 | 15 | 35 | 20 | 1.60 |
| Example 4 | Kapton80EN | 65 | 20 | 0 | 15 | 50 | 10 | 15 | 20 | 1.65 |
| Example 5 | Kapton80EN | 50 | 16 | 0 | 34 | 50 | 10 | 25 | 20 | 1.65 |
| Comparative | Kapton80EN | — | — | — | — | — | — | 60 | 20 | 0.93 |
| Example 1 | | | | | | | | | | |
| Comparative | Kapton80EN | 0 | 50 | 0 | 50 | 50 | 60 | 45 | 21 | 0.21 |
| Example 2 | | | | | | | | | | |
| Comparative | Kapton80EN | 0 | 10 | 0 | 90 | 50 | 60 | 50 | 20 | 0.90 |
| Example 3 | | | | | | | | | | |
| Comparative | Kapton80EN | 0 | 0 | 50 | 50 | 50 | 60 | 50 | 22 | 0.23 |
| Example 4 | | | | | | | | | | |

As shown in Table 1, it was found that the contact angle of water on the polyimide film subjected to an alkali treatment is smaller and the enhanced wetting property, as compared to that of the polyimide film (Comparative Example 1) which was not subjected to an alkali treatment. Furthermore, it was found that the contact angle of the polyimide film treated with an aqueous solution containing ethanol amine and potassium hydroxide is much smaller and the enhanced wetting property, as compared to that of the polyimide films (Comparative Example 2 to 4) treated with an aqueous sodium hydroxide solution or an aqueous potassium hydroxide solution.

Furthermore, as shown in Table 1, it was found that the polyimide metal laminates obtained from the polyimide films (Examples 1 to 4) treated with an aqueous solution containing ethanol amine and potassium hydroxide had enhanced peel strength, as compared to the polyimide metal laminates (Comparative Example 1 to 4) obtained from the polyimide films which were not subjected to an alkali treatment or the polyimide films treated with an aqueous sodium hydroxide solution or an aqueous potassium hydroxide solution.

### INDUSTRIAL APPLICABILITY

The polyimide film and the polyimide metal laminate provided in the present invention can be usefully used as a base material for printed wiring boards, a base material for an integrated suspension, a as base material for a wiring for IC packages, a flat heating unit, a base material for a wiring for LCDs and the like.

The present application claims a priority based on Application No. JP2005/112116 filed on Apr. 8, 2005. The contents described in the aforementioned application specification are all cited in the present specification.

1. A polyimide film subjected to a surface treatment with an aqueous solution containing an alcohol amine and an alkali metal hydroxide.

2. The polyimide film according to claim 1, wherein a weight content of the alcohol amine (A weight %) is not less than 5 weight % and not more than 75 weight %, a weight content of the alkali metal hydroxide (B weight %) is not less than 10 weight % and not more than 45 weight %, and a weight content of water (C weight %) is not less than 9 weight % and not more than 80 weight % in said aqueous solution.

3. The polyimide film according to claim 1, wherein said alcohol amine is one or more kinds selected from the group consisting of ethanol amine, propanol amine, butanol amine, diethanol amine and dipropanol amine, and said alkali metal hydroxide is one or more kinds selected from the group consisting of potassium hydroxide and sodium hydroxide.

4. The polyimide film according to claim 2, wherein said alcohol amine is one or more kinds selected from the group consisting of ethanol amine, propanol amine, butanol amine, diethanol amine and dipropanol amine, and said alkali metal hydroxide is one or more kinds selected from the group consisting of potassium hydroxide and sodium hydroxide.

5. The polyimide film according to claim 1, wherein said polyimide film contains a condensation polymer of a raw material composition containing an acid dianhydride component including at least one of a pyromellitic acid dianhydride and a biphenyl tetracarboxylic acid dianhydride, and a diamine component including at least one of phenylene diamine and diaminodiphenyl ether.

6. The polyimide film according to claim 2, wherein said polyimide film contains a condensation polymer of a raw material composition containing an acid dianhydride component including at least one of a pyromellitic acid dianhydride and a biphenyl tetracarboxylic acid dianhydride, and a diamine component including at least one of phenylene diamine and diaminodiphenyl ether.

7. The polyimide film according to claim 3, wherein said polyimide film contains a condensation polymer of a raw material composition containing an acid dianhydride component including at least one of a pyromellitic acid dianhydride and a biphenyl tetracarboxylic acid dianhydride, and a diamine component including at least one of phenylene diamine and diaminodiphenyl ether.

8. The polyimide film according to claim 4, wherein said polyimide film contains a condensation polymer of a raw material composition containing an acid dianhydride component including at least one of a pyromellitic acid dianhydride and a biphenyl tetracarboxylic acid dianhydride, and a diamine component including at least one of phenylene diamine and diaminodiphenyl ether.

9. A polyimide metal laminate having
the polyimide film according to claim 1,
a thermoplastic polyimide layer comprising a resin composition containing a thermoplastic polyimide placed on at least one surface of said polyimide film, and
a metal layer placed on the outer side of said thermoplastic polyimide layer.

10. A polyimide metal laminate having
the polyimide film according to claim 2,
a thermoplastic polyimide layer comprising a resin composition containing a thermoplastic polyimide placed on at least one surface of said polyimide film, and
a metal layer placed on the outer side of said thermoplastic polyimide layer.

11. A polyimide metal laminate having
the polyimide film according to claim 3,
a thermoplastic polyimide layer comprising a resin composition containing a thermoplastic polyimide placed on at least one surface of said polyimide film, and
a metal layer placed on the outer side of said thermoplastic polyimide layer.

12. A polyimide metal laminate having
the polyimide film according to claim 4,
a thermoplastic polyimide layer comprising a resin composition containing a thermoplastic polyimide placed on at least one surface of said polyimide film, and
a metal layer placed on the outer side of said thermoplastic polyimide layer.

13. A polyimide metal laminate having
the polyimide film according to claim 5,
a thermoplastic polyimide layer comprising a resin composition containing a thermoplastic polyimide placed on at least one surface of said polyimide film, and
a metal layer placed on the outer side of said thermoplastic polyimide layer.

14. A polyimide metal laminate having
the polyimide film according to claim 6,
a thermoplastic polyimide layer comprising a resin composition containing a thermoplastic polyimide placed on at least one surface of said polyimide film, and
a metal layer placed on the outer side of said thermoplastic polyimide layer.

15. A polyimide metal laminate having
the polyimide film according to claim 7,
a thermoplastic polyimide layer comprising a resin composition containing a thermoplastic polyimide placed on at least one surface of said polyimide film, and
a metal layer placed on the outer side of said thermoplastic polyimide layer.

16. A polyimide metal laminate having
the polyimide film according to claim 8,
a thermoplastic polyimide layer comprising a resin composition containing a thermoplastic polyimide placed on at least one surface of said polyimide film, and
a metal layer placed on the outer side of said thermoplastic polyimide layer.

17. A method for manufacturing a polyimide metal laminate comprising steps of:
subjecting at least one surface of a polyimide film to a surface treatment with an aqueous solution containing an alcohol amine and an alkali metal hydroxide,
forming a thermoplastic polyimide layer by coating the surface subjected to the surface treatment of said polyimide film with a resin composition containing a thermoplastic polyimide or a thermoplastic polyimide precursor and drying; and
forming a metal layer by heat-pressing a metal foil on said thermoplastic polyimide layer.
